(19) United States
(12) Patent Application Publication
(10) Pub. No.: US 2007/0083282 A1
(43) Pub. Date: Apr. 12, 2007

(54) Failover system and method for semiconductor manufacturing equipment

(76) Inventor: Dong-Ha Lim, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/522,318

(22) Filed: Sep. 18, 2006

(30) Foreign Application Priority Data
Oct. 12, 2005 (KR) 2005-96084

(51) Int. Cl. G06F 19/00

(52) U.S. Cl. 700/110; 700/108

(57) ABSTRACT

A failover system for semiconductor equipment includes an equipment group including equipment units configured to fabricate a semiconductor device. The system also includes an equipment sever group including equipment servers which communicate with the equipment units about processing parameter data associated with one or more operations of the equipment units. The system also includes a host computer which communicates with the equipment server group about the processing parameter data associated with the one or more operations of the equipment units. The system also includes an operator interface computer which communicates with the host computer about information associated with the fabrication of the semiconductor device wherein the host computer includes a cure recipe, the cure recipe being used to resolve an event that interrupts at least one of the equipment units and to restart the interrupted equipment unit.

### BACKGROUND

1. Field of the Invention

The present disclosure generally relates to systems and methods for semiconductor fabrication and, more particularly, to a failover system and method for semiconductor fabrication.

A claim of priority under 35 U.S.C. § 119 is made to Korean Patent Application 2005-96084 filed on Oct. 12, 2005, the entire contents of which are hereby incorporated by reference.

2. Description of Related Art

A number of unit steps are used in the semiconductor fabrication process. These unit steps include, for example, chemical vapor deposition, etching, measurement, and deposition. In addition, other such steps may also be used in the semiconductor fabrication process. A lot of the unit steps have to be carried out in with high precision. The high precision nature of these unit processes may make it difficult to control these processes manually. Therefore, different types of automatic controls are used to monitor and control the unit processes of semiconductor fabrication. Amongst the different types of controls, some automatic controls may also be used to ensure that the semiconductor fabrication process is carried out in a predetermined order.

FIG. 1 depicts a conventional method for controlling a semiconductor fabrication process. In particular, the conventional method discloses a process whereby the semiconductor fabrication process is interrupted under certain conditions and then restarted after treatment of the semiconductor material. As shown in FIG. 1, at step S10, an operator or designer may set certain operation conditions for the fabrication process. These operation conditions may be set at any time of the fabrication process. For example, these conditions may be set before, during, or after each unit process of the fabrication. At step S20, a check is performed as to whether there is a deviation from the operating conditions set in step S10. If there is a deviation, then at step S30 the semiconductor fabrication process is interrupted and a warning is generated. This warning may be generated as an audio signal, visual signal, or a combination of both. At step S40, an operator may sense the signal and may take steps to treat the semiconductor and/or correct the operating parameters set by the operator/designer. At step S50, the operator may restart the semiconductor fabrication equipment.

While the conventional semiconductor fabrication process may be used to stop the semiconductor fabrication when a deviation from operation parameters/operating condition is sensed, the conventional semiconductor fabrication process suffers from various shortcomings. For example, the conventional method requires the intervention of an operator upon issuance of warning signal to determine what steps need to be taken to treat the semiconductor and/or correct the operating parameters. Waiting for an operator to sense the warning signal, make this determination, and fix a problem in the semiconductor fabrication process may lead to delays in the semiconductor fabrication process.

Furthermore, in many instances, the input parameters used for setting the process conditions in a semiconductor fabrication process may change because of the use of different materials in the equipment. If an operator does not sense a warning signal and does not take steps to change the input parameters in time, there may also be delays in the semiconductor fabrication process. These delays may lead to a loss in production. Accordingly, there may be a need for a failover system for semiconductor fabrication equipment that may improve the efficiency of production as well as an operation of the equipment.

The present disclosure is directed towards overcoming one or more limitations of the prior art semiconductor fabrication system and process.

### SUMMARY OF THE INVENTION

One aspect of the present disclosure includes a failover system for semiconductor equipment. The failover system includes an equipment group including equipment units configured to fabricate a semiconductor device. The system also includes an equipment sever group including equipment servers which communicate with the equipment units about processing parameter data associated with one or more operations of the equipment units. The system also includes a host computer which communicates with the equipment server group about the processing parameter data associated with the one or more operations of the equipment units. The system also includes an operator interface computer which communicates with the host computer about information associated with the fabrication of the semiconductor device wherein the host computer includes a cure recipe, the cure recipe being used to resolve an event that interrupts at least one of the equipment units and to restart the interrupted equipment unit.

Another aspect of the present disclosure includes a method of operating a failover system for semiconductor equipment. The method comprises interrupting at least one of a plurality of equipment units included in an equipment group when processing conditions of the at least one of the plurality of equipment units are outside normal processing conditions. The method also comprises accessing the interrupted equipment unit with a cure recipe stored in a host computer. The method also comprises correcting parameters associated with one or more operations of the interrupted equipment unit with the stored cure recipe. The method also comprises restarting the interrupted equipment unit after correcting the parameters.

Yet another aspect of the disclosure includes a method of operating a failover system for semiconductor equipment. The method includes interrupting the semiconductor equipment when processing conditions of the equipment units are outside normal processing conditions. The method also includes accessing the interrupted semiconductor equipment with a cure recipe stored in a host computer. The method also includes correcting parameters associated with one or more operations of the interrupted semiconductor equipment with the stored cure recipe. The method also includes restarting the interrupted semiconductor equipment after correcting the parameters. The method also includes informing the host computer about one or more measures involved in restarting the interrupted semiconductor equipment.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified. In the figures:

FIG. 1 is a flow chart showing a systemic operation of semiconductor manufacturing equipment by a conventional art;

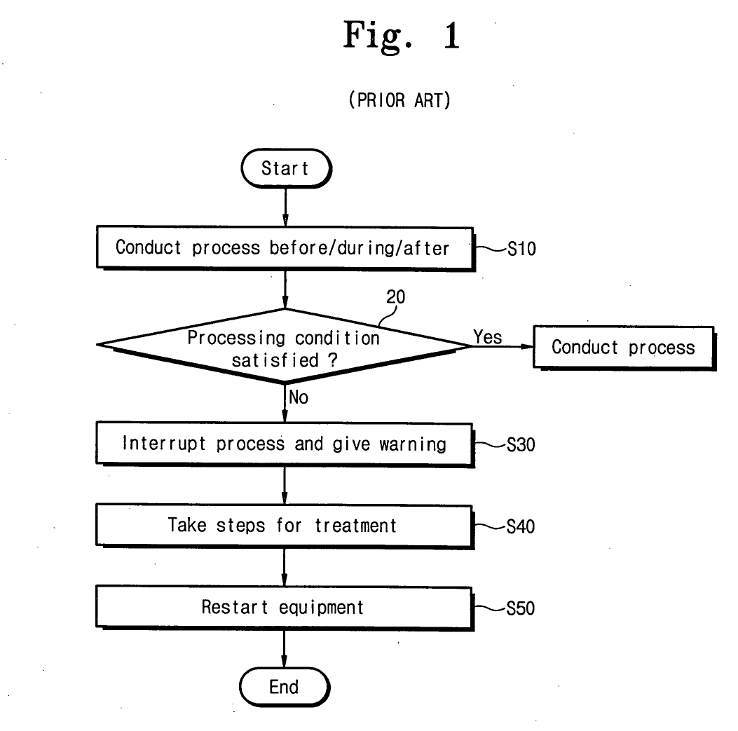

FIG. 2 is a block diagram illustrating a failover system for semiconductor manufacturing equipment in accordance with an exemplary embodiment of the present invention; and

FIG. 3 is a flow chart showing a systemic operation of the failover system for semiconductor manufacturing equipment in accordance with an exemplary embodiment of the present invention.

### DESCRIPTION OF EMBODIMENTS

Preferred embodiments of the invention will be described below in more detail with reference to the accompanying drawings. The invention may, however, be embodied in different forms and should not be constructed as limited to the embodiments set forth herein. Rather, these embodiments are provided so that this disclosure will be thorough and complete, and will fully convey the scope of the invention to those skilled in the art.

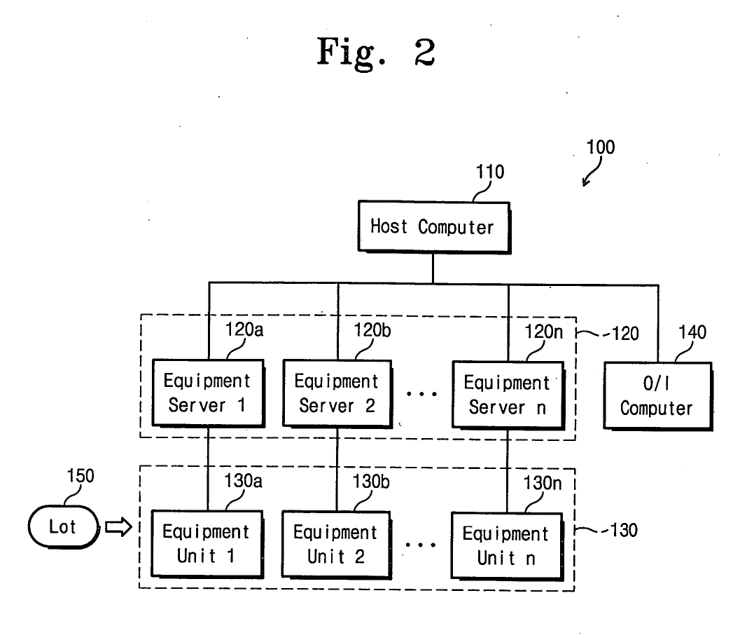

FIG. 2 is a block diagram illustrating a failover system 100 for semiconductor manufacturing equipment in accordance with an exemplary embodiment of the invention. Referring to FIG. 2, the semiconductor equipment system 100 includes a manufacturing equipment group 130. In manufacturing equipment group 130, processing steps are carried out with a lot 150. The lot 150 includes wafers that may have been through a predetermined processing step. The system 100 also includes an equipment server group 120 that is connected with the manufacturing equipment group 130 by a connection method such as, for example, an on-line network. The system 100 also includes a host computer 110 that is connected with the equipment server group 120 using the on-line network and an operator interface (O/I) computer 140 connected with the host computer 110 using the on-line network.

The manufacturing equipment group 130 includes a plurality of manufacturing equipment units 130a, 130b, . . . , and 130n (i.e., 130a˜130n). In addition, the equipment server group 120 directly controls the manufacturing equipment group 130 so as to implement the semiconductor fabrication processing steps. To this end, the equipment server group 120 may include various components. For example, the equipment server group 120 may include a plurality of equipment servers 120a, 120b, . . . , and 120n (i.e., 120a˜120n) that are each connected to corresponding manufacturing equipment units 130a˜130n. In an exemplary embodiment, a manufacturing equipment unit 130a and the equipment server 120a are coupled to communicate with each other using standard data communication protocols such as, for example, Semi-Equipment Communication Standard (SECS). Likewise, other manufacturing equipment units 130b˜130n are coupled with the corresponding equipment servers 120b˜120n for bilateral communication with each other using the

The equipment server group 120 communicates data with the host computer 110. This communication may be effectuated by various communication protocols such as, for example, Transmission Control Protocol/Internet Protocol (TCP/IP). The host computer 110 has a data base which stores information used by the equipment server 120 in controlling the manufacturing equipment group 130. In particular, the data base of the host computer 110 stores data for optimizing the equipment units 130a˜130n arranged on the semiconductor fabrication line. This data may include, for example, processing orders of the plurality of equipment units 130a˜130n, processing environments, recipes for processing conditions, and so on. The recipe for processing conditions may include data such as, for example, processing parameters (temperature, pressure, time, etc), specification data (processing ranges from the minimum to the maximum), and practical processing data (data minimizing defects).

The host equipment 110 may be configured to determine whether the processing parameter data used by the equipment units 130a˜130n is within acceptable ranges. In order to make this determination, the host computer 110 receives all the data of processing parameters from the manufacturing equipment units 130a˜130n in real time. Furthermore, the host computer 110 finds reference parameter data for each equipment unit from the data base and then, based on a comparison between the data received from the manufacturing equipment units 130a˜130n and that received from its database, determines whether the processing parameter data of the equipment units 130a˜130n are confined within predetermined reference ranges.

As mentioned above, the data stored in the host computer 110 includes cure recipes. A cure recipe may be provided for a number of reasons. For example, a cure recipe may be provided for analyzing the reasons that cause the manufacturing equipment group 130 to be shut down and finding solutions to automatically restart the equipment group 130. This cure recipe may be a recipe commonly adaptable to the equipment group 130, or a recipe independently adaptable to each equipment unit. The event that caused the shut down may be reported and logged in the host computer 110. Various criteria may be used to determine which events that caused the shut down may be reported. For example, if the equipment group 130 restarts with the cure recipe, information related to the cure recipe along with the problems resolved are reported to the host computer 110. The host computer 110 may then store and analyze these events.

The O/I computer 140 is connected with the host computer 110. The O/I computer 140 may be used for various functions. In an exemplary embodiment, the O/I computer 140 may be used for bidirectional data transfer between the system 100 and the operator. For example, the O/I computer 140 may be used to provide information associated with the progress of the semiconductor fabrication process to the operator. In addition, the O/I computer 140 may be used to transfer information from the operator to the system 100. For example, the operator may input basic production data via O/I computer 140 to the system 100. This production data may include information pertaining to the semiconductor fabrication process carried out by system 100. For example, this production data may include identification numbers of the corresponding lots or equipment units that need to conduct the processing steps. Thereafter, the host computer 110 may evaluate other data associated with of the semiconductor fabrication process which is to be applied to lot 150 with reference to the basic processing data input by the operator. Thereafter, a predetermined processing step is carried out to the target lot 150.

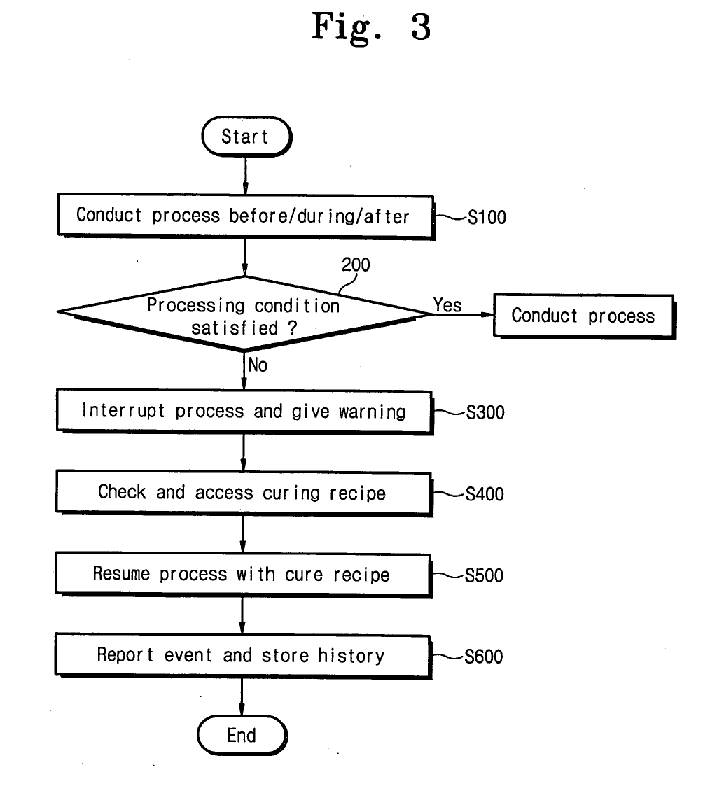

FIG. 3 is a flow chart showing a systemic operation of the failover system for the semiconductor manufacturing equipment in accordance with an exemplary embodiment of the invention.

Referring to FIG. 3, at step S100, an operator or designer may set certain operation conditions for the fabrication process. These operation conditions may be set at any time of the fabrication process. For example, these conditions may be set before, during, or after each unit process of the fabrication. At step S200, the system determines whether there has been an abnormal deviation from the regular operating conditions. If there has been an abnormal deviation, then at step S300, the semiconductor fabrication process is interrupted and a warning signal is generated. This warning may be generated as an audio signal, visual signal, or a combination of both.

For example, when the lot 150 containing wafers is loaded in the semiconductor equipment system 100, an operator inputs basic processing data, such as identification numbers of the lot 150 and the equipment units 130a˜130n to conduct the corresponding processes, through the O/1 computer 140. Based on the basic data input, the host computer 110 finds an appropriate recipe from the data base and enables the semiconductor processing step to be carried out on the lot 150 corresponding thereto.

In the manufacturing equipment group 130, at step S300, one equipment unit, e.g., 130a, may be shut down from operation because of a deviation from normal processing conditions (as determined at step S200). This shut down may be due to a simple problem or a reason that does not affect the qualities of the semiconductor product being manufactured at the time. For example, certain components of equipment unit 130a may be changed during the semiconductor fabrication process. These components may include, for example, a filament. Because of the change in components/materials in equipment 130 during the semiconductor fabrication process, there may be a difference in the input parameters set for the processing conditions. This difference in input parameters may cause the shut down of the equipment during the semiconductor fabrication process.

However, the difference between the input parameters may not be large enough to warrant the shut down of the equipment. Therefore, in an exemplary embodiment, a two-way communication link between the host computer 110 and the equipment server group 120 may be formed. This link may be used for communication between the host computer 110 and the equipment server group 120. For example, this link may be used for the host computer 110 to receive data of processing parameters from the equipment units 130a˜130n in real time. As the host computer 110 communicates with the equipment sever group 120, the host computer 110 may quickly identify the data of processing parameters set in the equipment units 130a˜130n.

If the processing parameter data are not over the predetermined reference ranges, the equipment units 130a˜130n are determined to be operating under normal conditions and thereby the processing steps continue to proceed. On the other hand, if the processing parameter data of the equipment unit 130a are over the predetermined reference ranges, the host computer 110 interlocks the equipment unit 130a to interrupt a current processing step and to generate a warning.

In an exemplary embodiment, a cure recipe may be used to fix the problem that generates an interrupt. For example, at step S300, a simple interruption may be generated because of a difference among input parameters for setting the processing conditions. Because of this interruption, the equipment unit 130a is shut off in work and generates a warning. If the equipment unit 130a is interrupted in operation, the cure recipe information stored in the host computer 110 is loaded down into the equipment server 120a controlling the equipment unit 130a that is inactive at this time. At step S400, the cure recipe information provided to the equipment server 120a is used to resolve the problem that interrupted an operation of the equipment unit 130a and to restart the equipment unit 130a. Namely, at step S500, the cure recipe is used to correct input parameters used for setting processing conditions in the interrupted equipment 130a and then to resume the operation of the equipment unit 130a.

If the interrupted equipment unit 130a resumes its operation, the host computer 110 is supplied with information associated with the reasons for stopping the operation of the equipment unit 130a and the measures taken for solving the problems. For example, the information supplied may include a reason for the interruption of the equipment unit and the associated cure recipe used for fixing the problem. At step S600, the host computer 110 stores and analyzes this information. This stored information may be used to analyze the reasons for interruption, the measures taken to resolve them, and improve the semiconductor fabrication process based on the analysis. The improvements may include, for example, providing additional facilities for managing the equipment and product quality.

The proposed failover system may be used in any semiconductor fabrication process. As described above, the system implements an operation of the semiconductor equipment system 100 by conducting a failover operation for the manufacturing equipment group 130 by means of the cure recipe prepared in the host computer 110. This failover process may be used against a simple process interruption that does not affect the qualities of semiconductor product. Furthermore, this unmanned automatic operation mode may be selectable in accordance with conditions set by an operator.

Furthermore, the disclosed system implements a failover system that automatically diagnoses problems in semiconductor equipment. In addition, the disclosed system, upon generation of an error or interlock, uses a pre-programmed curing scheme, and corrects the problems to restart the equipment. Thus, the disclosed system may prevent the loss of production and may maximize the efficiency of production in the environment of unmanned automatic manufacturing.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A failover system for semiconductor equipment, comprising:
an equipment group including equipment units configured to fabricate a semiconductor device;
an equipment sever group including equipment servers which communicate with the equipment units about processing parameter data associated with one or more operations of the equipment units;
a host computer which communicates with the equipment server group about the processing parameter data associated with the one or more operations of the equipment units; and
an operator interface computer which communicates with the host computer about information associated with the fabrication of the semiconductor device,
wherein the host computer includes a cure recipe, the cure recipe being used to resolve an event that interrupts at least one of the equipment units and to restart the interrupted equipment unit.

2. The failover system as set forth in claim 1, wherein the cure recipe is commonly applied to all the equipment units or independently applied to each equipment unit.

3. The failover system as set forth in claim 2, wherein the cure recipe is used to correct one or more input parameters used for setting one or more processing conditions of the interrupted equipment unit.

4. The failover system as set forth in claim 1, wherein the host computer stores information related to a measure taken that automatically restarts the interrupted equipment unit.

5. The failover system as set forth in claim 1, wherein the host computer further includes a reference range and receives the processing parameter data of the equipment units from at least one of the equipment servers, and determines whether the received processing parameter data is outside the reference range.

6. The failover system as set forth in claim 1, wherein the fabrication of the semiconductor device includes a processing step and the cure recipe operates in at least one of times before, during, and after the processing step.

7. A method of operating a failover system for semiconductor equipment, the method comprising:
interrupting at least one of a plurality of equipment units included in an equipment group when processing conditions of the at least one of the plurality of equipment units are outside normal processing conditions;
accessing the interrupted equipment unit with a cure recipe stored in a host computer; and
correcting parameters associated with one or more operations of the interrupted equipment unit with the stored cure recipe; and
restarting the interrupted equipment unit after correcting the parameters.

8. The method as set forth in claim 7, wherein the cure recipe is commonly applied to all the equipment units or independently applied to each equipment unit.

9. The method as set forth in claim 7, wherein accessing the interrupted equipment unit comprises:
downloading information of the cure recipe from the host computer into an equipment server group including equipment servers configured to control the plurality of equipment units of the equipment group.

10. The method as set forth in claim 7, furthering including automatically correcting the parameters with the stored cure recipe, the automatic correction being carried out after accessing the interrupted equipment unit with the cure recipe and before restarting the interrupted equipment unit.

11. The method as set forth in claim 7, wherein interrupting the equipment unit is carried out in one of times before, during, and after a processing step.

12. The method as set forth in claim 11, wherein accessing the interrupted equipment unit with the cure recipe is carried out in one of times before, during, and after the processing step.

13. The method as set forth in claim 7 further comprising, after restarting the interrupted equipment unit, informing the host computer of a measure taken that restarts the interrupted equipment unit.

14. The method as set forth in claim 13, wherein restarting the interrupted equipment unit comprises storing information of the measure taken into the host computer.

15. A method of operating a failover system for semiconductor equipment, the method comprising:
interrupting the semiconductor equipment when processing conditions of the equipment units are outside normal processing conditions;
accessing the interrupted semiconductor equipment with a cure recipe stored in a host computer;
correcting parameters associated with one or more operations of the interrupted semiconductor equipment with the stored cure recipe;
restarting the interrupted semiconductor equipment after correcting the parameters; and
informing the host computer about one or more measures involved in restarting the interrupted semiconductor equipment.

16. The method as set forth in claim 15, wherein interrupting the semiconductor equipment is carried out in one of times before, during, and after a processing step.

17. The method as set forth in claim 16, wherein accessing the semiconductor equipment with the cure recipe is carried out in one of times before, during, and after the processing step.

18. The method as set forth in claim 16, furthering including automatically correcting the parameters with the stored cure recipe, the automatic correction being carried out after accessing the interrupted equipment unit with the cure recipe and before restarting the interrupted equipment unit.

19. The method as set forth in claim 15, wherein the semiconductor equipment is included in an equipment group that includes a plurality of semiconductor equipment units that conduct unit processing steps.

20. The method as set forth in claim 19, wherein the cure recipe is commonly applied to all the semiconductor equipment units included in the equipment group or independently applied to each semiconductor equipment unit.
